(19) United States
(12) Patent Application Publication
(10) Pub. No.: US 2005/0147027 A1
(43) Pub. Date: Jul. 7, 2005

(54) Method, system and hub for loop initialization

(75) Inventor: Harri Hyytiainen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/058,598

(22) Filed: Feb. 16, 2005

Related U.S. Application Data
(63) Continuation of application No. PCT/FI03/00565, filed on Jul. 14, 2003.

(30) Foreign Application Priority Data
Aug. 30, 2002 (FI) 20021553

(51) Int. Cl. H04L 12/26

(52) U.S. Cl. 370/216

(57) ABSTRACT

The present invention describes a method and system for initializing a redundant loop system comprising one or more hubs, plurality of nodes connected to the hubs, wherein the redundant loop system comprises two or more loops. The loops in the redundant loop system are classified as being either in active or standby state. However, at least one of the loops is in active state. The classification is made for the initialization process of the redundant loop system. In the method, the redundant loop system is initialized so that during the initialization process traffic is transferred via the active loop(s) while the standby loop(s) is/are initialized.

The present invention relates computer systems.

In particular, the present invention relates to a novel and improved method, system and hub for initializing redundant loop systems.

### BACKGROUND OF THE INVENTION

A Fibre Channel Arbitrated Loop (FC-AL) is a media used to transfer commands and data e.g. between storage devices (like hard disks) and processor units (like servers or workstations). From the Fibre Channel (FC) point of view both are nodes. Fibre Channel in general exists in several topologies (point-to-point, fabric and loop). Since the F-CAL is a loop topology in which the nodes are in logical circular so that data within loop may be usually passed through other nodes when two nodes are communicating. Removing a node may cut the path between nodes. To prevent the FC-AL to be fully unusable when single node is removed, unpowered or broken, bypass circuitry is used to pass the data over such node. Usually the bypass circuitry is gathered into one entity called a Fibre Channel hub. The hub can further have some intelligence and it can be controlled outside, therefore being called as a managed Fibre Channel hub. The managed FC hub can for example be commanded to bypass any of the connected nodes (hub ports).

Certain operations and incidents in the loop may cause the loop to initialize, which at least in some extent, may disturb the operation of the loop and hence excessive loop initializations are undesired. At least inserting a node and restarting a (processor) node will trigger loop initialization. Some commercial Fibre Channel hubs have, for example, features like Loop Initialization Primitive (LIP) isolation to limit its visibility in the loop. Loop initialization action suspends normal operation of the loop while the entire population on the loop acquires or verifies the current port addresses and is assigned an AL_PA (Arbitrated Loop Physical Address). Although the LIPs may sometimes happen fast, throughput-sensitive applications, such as video streaming and tape backups, are sensitive to hiccups.

The problem with the current loop solutions is that, e.g. in the Fibre Channel, loop initialization disturbs the ongoing loop traffic. The Fibre Channel systems have to take into account that loop initializations may happen and try to resend the data or otherwise handle the situation. This seems to be especially harmful for tape systems wherein repeating a command may spoil the logical structure of the data.

### SUMMARY OF THE INVENTION

The present invention describes a method, system and hub for initializing a redundant loop system comprising a hub and plurality of nodes connected to the hub. In general, the term redundant describes computer or network system components, such as fans, hard disk drives, servers, switches, and telecommunication links that are installed to back up primary resources in case of a failure.

There may be several reasons why the redundant loop system has to be initialized. These reasons comprise e.g. inserting a node into the loop, restarting a node within the loop, replacing a node of the loop or removing a node from the loop.

The present invention describes a solution for avoiding the disturbance of the initialization process to the ongoing loop traffic. In the method, the loops in the redundant loop system are classified as being either in an active or standby state. However, at least one of the loops is in active state. The classification is made for the initialization process of the redundant loop system. At other times, it is not necessary to maintain the classification but several loops can be used simultaneously, e.g. for load balancing purposes. The loops of the redundant loop system are initialized so that during the initialization process traffic is transferred via the active loop(s) while the standby loop(s) is/are initialized. When the initialization process of the standby loop is over, in case the redundant loop system comprises two loops, the initialized loop is set as a new active loop and the previous active loop as standby loop. Now the current active loop has been initialized and the previous active loop (now standby loop) is ready to be initialized. The previous loop initialization process can also be applied when the redundant loop system comprises more than two loops. The process continues until all the loops have been initialized.

In one embodiment of the invention, the loop initialization loop-by-loop is implemented so that the hub ports of the hub are controlled so that one or more standby loops are initialized at a time and, at the same time, at least one loop is in active state.

In one embodiment of the invention, the redundant loop system is a Fibre Channel Arbitrated Loop.

The present invention has several advantages over the prior-art solutions. The present invention fully isolates the loop initialization so that an active loop operation is not affected.

The present invention also provides an important part for implementing fluent hot swap procedure. This is an important feature especially in communication and telecommunication systems in which the amount of service breaks must be minimized.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a physical view of a system configuration of the present invention,

FIG. 2 is a physical view of a system configuration of the present invention,

FIG. 3 is a logical view of the system configuration of FIG. 1 or 2,

FIG. 4 is a logical wiring view of the system configuration of FIG. 1 or 2,

FIG. 5 is a logical view of the system configuration of FIG. 1 or 2 wherein server SRVB is removed from the loop,

FIG. 6 is a logical wiring view of the system configuration of FIG. 1 or 2 wherein server SRVB is removed from the loop,

FIG. 7 is a logical view of the system configuration of FIG. 1 or 2 wherein server SRVB is inserted into the loop,

FIG. 8 is a logical wiring view of the system configuration of FIG. 1 or 2 wherein server SRVB is inserted into the loop,

FIG. 9 is a logical view of the system configuration of FIG. 1 or 2 wherein server SRVB is inserted into the loop,

FIG. 10 is a logical wiring view of the system configuration of FIG. 1 or 2 wherein server SRVB is inserted into the loop,

FIG. 11 is a logical view of the system configuration of FIG. 1 or 2 wherein server SRVB is inserted into the loop,

FIG. 12 is a logical wiring view of the system configuration of FIG. 1 or 2 wherein server SRVB is inserted into the loop, and

FIG. 13 is an exemplary hub utilized in the present invention.

### DETAILED DESCRIPTION OF THE INVENTION

Reference will now be made in detail to the embodiments of the present invention, examples of which are illustrated in the accompanying drawings.

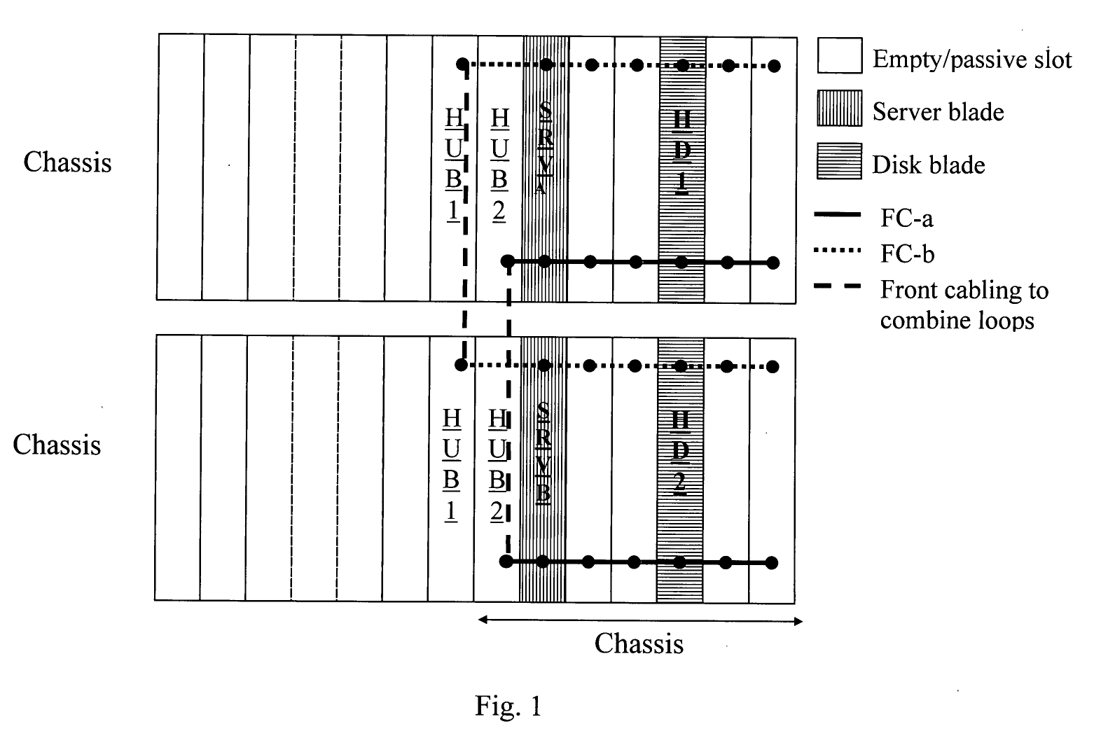

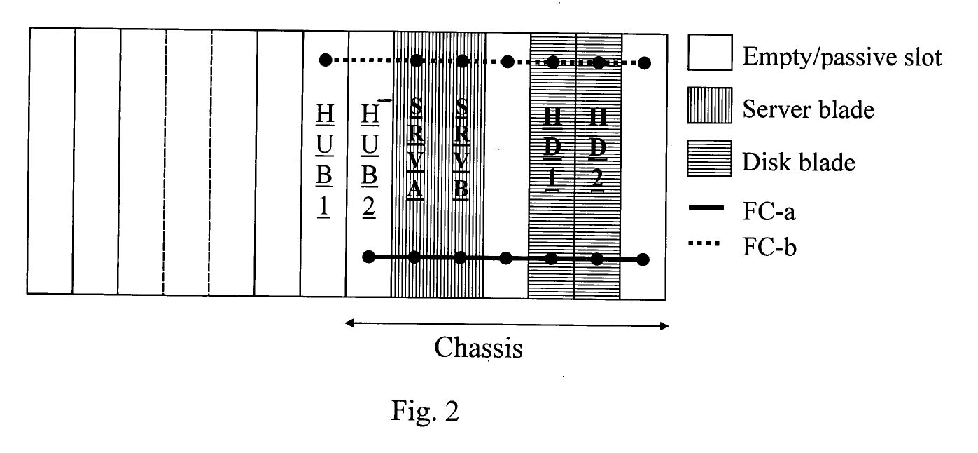

FIGS. 1 and 2 represent exemplary physical views of the blade disk configuration within which the present invention can be implemented. The difference between FIG. 1 and FIG. 2 is that in FIG. 1 also the chassis is redundant. In other words, the upper halves of the chasses are coupled and, correspondingly, the lower upper halves of the chasses are coupled. In both figures, the blade disk configuration comprises redundant disks and servers. In FIG. 1, the hubs HUB1 and HUB2, servers SRVA and SRVB and hard disks HD1 and HD2 are separated between two chassis halves. In FIG. 2, all the above-mentioned nodes are collected within one chassis halve.

FIGS. 1 and 2 describe redundant loop systems, i.e. there exists two loops wherein for the initialization process, one of the loops has been defined as the active loop and the other one as the standby loop. The dotted line represents one loop (FC-b) and the solid line (FC-a) the other. The configuration of FIG. 1 has duplicated FC-AL (Fibre Channel Arbitrary Loop) channel in backplane and FC-AL loops can be constructed from chassis halve elements. In a chassis halve, there are max. 6 blades and hence the loop consist of N*6 blades (there may be empty blades as well).

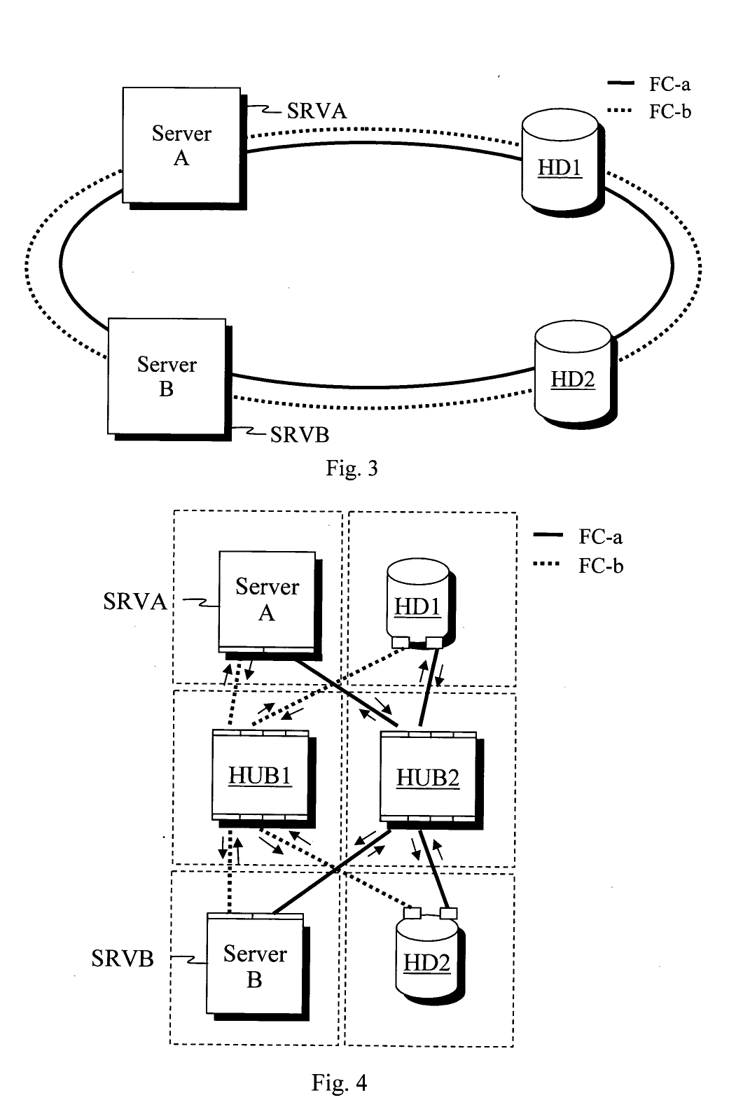

FIG. 3 represents a logical view of the system configuration of FIGS. 1 and 2. FIG. 3 comprises redundant FC-AL loops. Traffic in a loop will go in one direction through the nodes (disks or servers of FIGS. 1 and 2). However, traffic can be transmitted in full duplex mode (both nodes can send and receive at the same time) between two nodes although traffic is transmitted in one direction in the loop.

The solid line represents the active loop (FC-a) and the dotted line (FC-b) the standby loop.

FIG. 4 is a logical wiring view of the system configuration of FIGS. 1 and 2 and the logical view of FIG. 3. FIG. 4 comprises hard disks HD1 and HD2, hubs HUB1 and HUB2 and servers A and B. Each hard disk and server is connected to both of the hubs. Therefore, FIG. 4 comprises two separate loops, FC-a (solid lines) and FC-b (dotted lines).

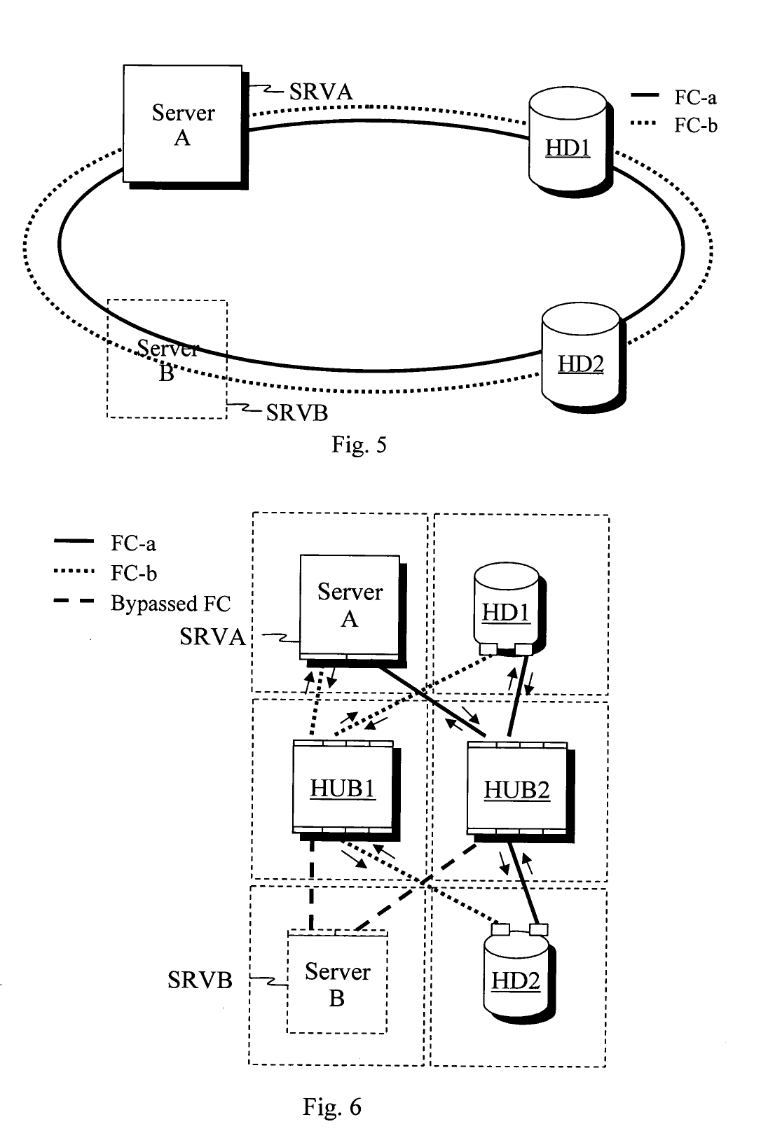

FIGS. 5 and 6 represent an example in which server SRVB is removed. FIG. 5 represents a logical view of the configuration. The logical wiring view of FIG. 5 is represented in FIG. 6. Server SRVB ports are bypassed to keep the loops sound. Bypassed connections are shown with longer dotted lines.

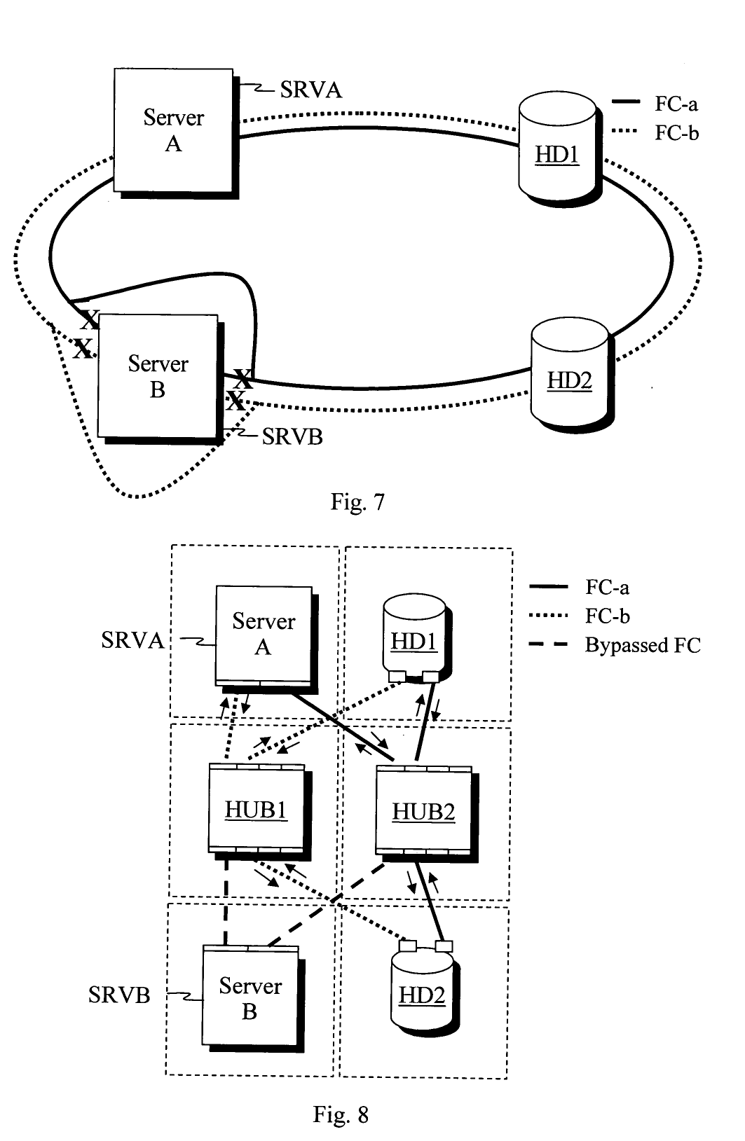

FIGS. 7-12 represent an example in which server SRVB is inserted into the loops. At first, server SRVB is bypassed from both FC channels. This enables the procedure that the loops can be initialized one by one. The logical wiring view of FIG. 7 is represented in FIG. 8 in which server SRVB ports are bypassed. Bypassed connections are shown with longer dotted lines.

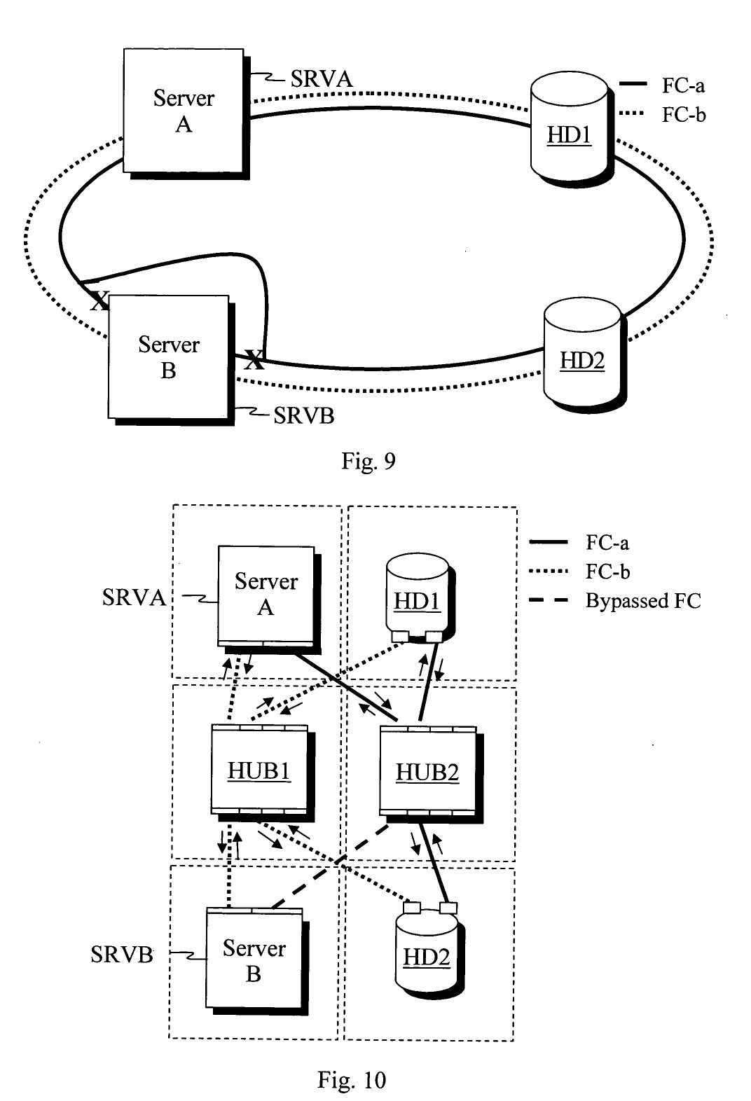

In FIG. 9, server SRVB is bypassed from FC-a loop (active loop) meanwhile FC-b loop (standby loop) is being initialized. Bypassed connections are shown with longer dotted lines. The logical wiring view of FIG. 9 is represented in FIG. 10. However, now server SRVB ports are bypassed in hub HUB2. The bypassed connection is shown with longer dotted lines.

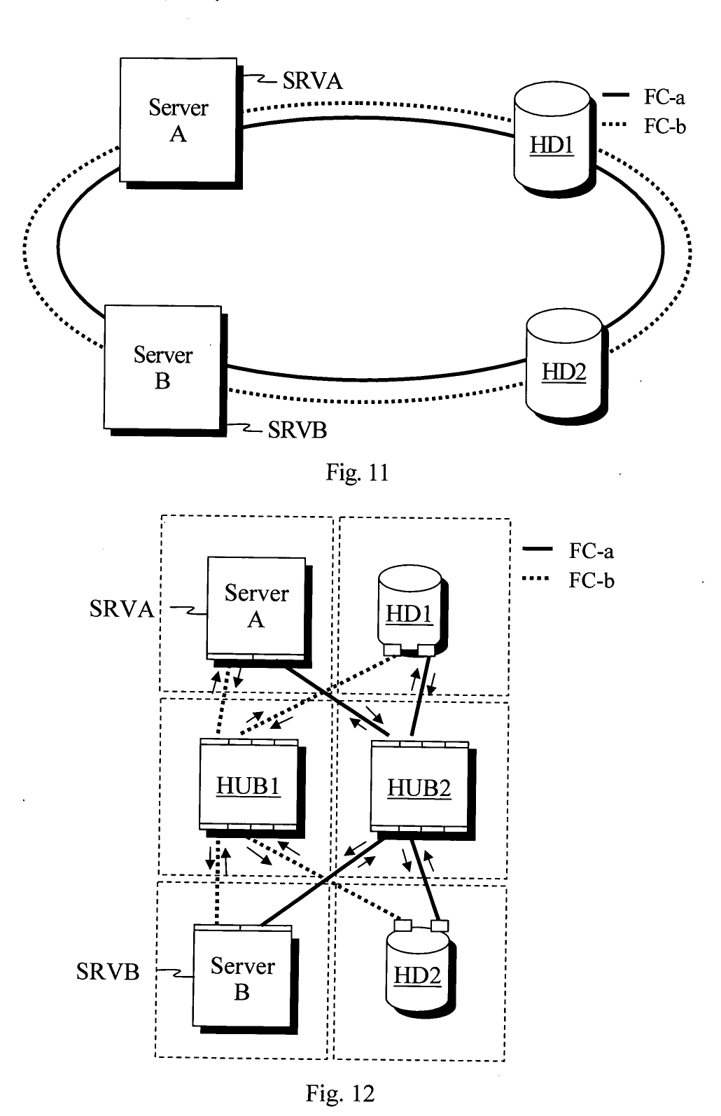

FIG. 11 represents the situation in which FC-b is already initialized and set in active state while FC-a is set in standby state. FC-a can now be initialized without any harmful effects on FC-b. The logical wiring view of FIG. 11 is represented in FIG. 12. In FIG. 12, both loops (FC-a, FC-b) have been initialized.

FIGS. 1-12 describe a redundant loop system comprising only two loops. A redundant loop system may, of course, comprise more than two loops. Nevertheless, the initialization process is the same, i.e. initializing the redundant loop system so that during the initialization process traffic is transferred via the active loop(s) while the standby loop(s) is/are initialized.

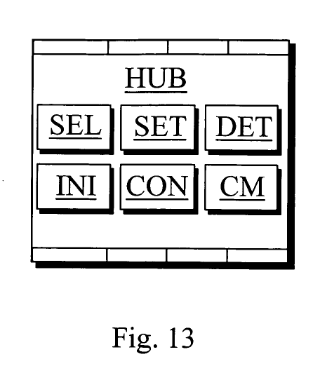

FIG. 13 represents a hub comprising classifying means CM for classifying the loops as being either in an active or standby state, selecting means SEL for selecting one or more standby loops of the redundant loop system, initializing means INI for initializing the standby loop(s) and setting means SET for changing the state of a loop to active or standby. Furthermore, the hub comprises controlling means CON for controlling the hub ports so that one or more standby loops are initialized at a time. With the controlling means the hub ports are set either in bypass or pass state. The hub comprises also detecting means DET for detecting events that trigger the initialization process of the redundant loop system, the initialization process triggered by one of the following reasons: inserting a node into the loop, restarting a node within the loop, replacing a node of the loop or removing a node from the loop. The aforementioned means are implemented in a way known to a man skilled in the art and are therefore not described in more detail.

In FIG. 13, all the needed intelligence for one by one initialization process described in the present invention is accumulated in the hub. In other embodiments, the intelligence can be divided between the hub and the device managing the hub or the intelligence can be wholly placed in the managing device.

It is obvious to a person skilled in the art that with the advancement of technology, the basic idea of the invention may be implemented in various ways. The invention and its embodiments are thus not limited to the examples described above, instead they may vary within the scope of the claims.

1. A method for initializing a redundant loop system comprising one or more hubs, plurality of nodes connected to the hubs, wherein the redundant loop system comprises two or more loops, wherein the method comprises the step of:
initializing the redundant loop system when loop initialization is triggered;
characterized in that the method further comprises the steps of:
classifying the loops in the redundant loop system as being either in active or standby state, at least one of the loops being in active state; and
bypassing at least one node connected to an active loop and a standby loop;
initializing the standby loop while traffic is transferred using the active loop;
changing the state of the initialized standby loop into active;
changing the state of the previous uninitialized active loop into standby; and
initializing the new standby loop.

2. The method according to claim 1, characterized in that the redundant loop system is a Fibre Channel Arbitrated Loop.

3. The method according to claim 1, characterized in that the initialization process is triggered by one of the following reasons:
inserting a node into the loop;
restarting a node within the loop;
replacing a node of the loop; or
removing a node from the loop.

4. The method according to claim 1, characterized in that when initialization of a loop is to be executed the method further comprises the step of:
controlling the hub ports so that one or more standby loops are initialized at a time.

5. A system for initializing a redundant loop system comprising two or more loops, the system comprising:
one or more hubs (HUB, HUB1, HUB2);
plurality of nodes (SRVA, SRVB, HD1, HD2) connected to the hubs (HUB1, HUB2),
characterized in that the system further comprises:
classifying means (CM) configured to classify the loops in the redundant loop system as being either in an active or a standby state;
controlling means (CON) configured to bypass at least one node connected to an active loop and a standby loop;
selecting means (SEL) configured to select the standby loop;
initializing means (INI) configured to initialize the standby loop while traffic is transferred using the active loop;
setting means (SET) configured to change the state of the initialized standby loop into active and to change the state of the previous uninitialized active loop into standby; and
initializing means (INI) configured to initialize the new standby loop.

6. The system according to claim 5, characterized in that the redundant loop system is a Fibre Channel Arbitrated Loop.

7. The system according to claim 5, characterized in that the system comprises detecting means (DET) configured to detect events that trigger the initialization process of the redundant loop system, the initialization process being triggered by one of the following reasons:
inserting a node into the loop;
restarting a node within the loop;
replacing a node of the loop; or
removing a node from the loop.

8. The system according to claim 5, characterized in that controlling means (CON) are configured to control the hub (HUB, HUB1, HUB2) ports so that one or more standby loops are initialized at a time.

9. The system according to claim 5, characterized in that the system comprises a managing device configured to control the hub (HUB, HUB1, HUB2).

10. A hub for a redundant loop system, wherein plurality of nodes (SRVA, SRVB, HD1, HD2) are connected to the hub (HUB, HUB1, HUB2),
characterized in that the hub (HUB, HUB1, HUB2) comprises:
classifying means (CM) configured to classify the loops in the redundant loop system as being either in an active or a standby state;
controlling means (CON) configured to bypass at least one node connected to an active loop and a standby loop;
selecting means (SEL) configured to select the standby loop;
initializing means (INI) configured to initialize the standby loop while traffic is transferred using the active loop;
setting means (SET) configured to change the state of the initialized standby loop into active and to change the state of the previous uninitialized active loop into standby; and
initializing means (INI) configured to initialize the new standby loop.

11. The hub according to claim 10, characterized in that the redundant loop system is a Fibre Channel Arbitrated Loop.

12. The hub according to claim 10, characterized in that the hub (HUB, HUB1, HUB2) comprises detecting means (DET) configured to detect events that trigger the initialization process of the redundant loop system, the initialization process being triggered by one of the following reasons:
inserting a node into the loop;
restarting a node within the loop;
replacing a node of the loop; or
removing a node from the loop.

13. The hub according to claim 10, characterized in that the controlling means (CON) are configured to control the hub (HUB, HUB1, HUB2) ports so that one or more standby loops are initialized at a time.

14. The hub according to claim 10, characterized in that a managing device connected to the hub (HUB, HUB1, HUB2) comprises controlling means (CON) configured to control the hub (HUB, HUB1, HUB2) ports so that one or more standby loops are initialized at a time.
